(19) United States
(12) Patent Application Publication
(10) Pub. No.: US 2008/0172844 A1
(43) Pub. Date: Jul. 24, 2008

(54) Yard tool harness tie-down and process for making same

(76) Inventor: Edward Patrick Hurley, Sarasota, FL (US)

Correspondence Address: Edward P. Hurley, 1214 Western Pine Circle, Sarasota, FL, 34240, US

(21) Appl. No.: 12/079,025

(22) Filed: Mar. 24, 2008

Related U.S. Application Data
(63) Continuation-in-part of application No. 11/008,037, filed on Dec. 9, 2004, now abandoned.

(51) Int. Cl. B68B 5/00; B23P 11/00

(52) U.S. Cl. 24/164; 29/428

(57) ABSTRACT

A yard tool harness tie-down with a band, the band generally connected above a yard tool equilibrium point, the band having a north brace, the band having a south brace, the band having an east brace, the band having a west brace, the north brace having to be connected to a harness, the south brace connected to a swivel button, the swivel button having to connect to a harness clip, the harness clip having to connect to a plurality of yard tools, the east brace connected to a fixed tie-down, the fixed tie-down connected to a outer union, the west brace connected to an adjustable tie-down, the adjustable tie-down connected to a outer union, the inner union having to couple with the outer union, and the inner and outer unions having to tie down the yard tool harness close to the harness clip.

### CROSS REFERENCE TO RELATED APPLICATIONS

This is a continuation in part of Ser. No. 11/008,037, filed on Dec. 9, 2004.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of grounds maintenance and more specifically to a yard tool harness tie-down and process for making same.

Some handheld yard tools come with a harness that attaches near a tool equilibrium point and can be suspended on one or two shoulders to help absorb vertical forces and loads that translate energy during yard work. Harnesses are typically made of flexible thin material to create more work options for handheld yard tools. There are many harnesses available for purchase everywhere from full-body tree trimmer belts to smaller single loop camera holders. Medium sized harnesses like a double shoulder loop connector must be worn when handling more elaborate yard equipment like a circular saw blade yard tool.

A harness can be suspended vertically upward by a human and can usually droop downward when stored. Several problems can arise when a harness is allowed to hang freely from a power tool. First, it is sometimes cumbersome to find a clean surface for a harness to rest on during yard tool preparations which could increase cleaning chores. Secondly, it is possible to trip over a harness that declines onto a grounds surface. A harness can get snagged on other tools when being dragged from a shelter-which could cause other sharp tools to fall or scatter apart. Another design consideration is that a harness is usually made of combustible material that could melt when allowed to drape over a hot motor. Likewise, an elongated harness can be exposed to fuel, grease, oil and other power tool contaminants. Yard tool parts can also jar loose when a harness has freedom to sail like that of a US flag on a pole, particularly in high speed transport. The ripple effect can also fray and damage a harness. Finally, harnesses could become a safety concern when harness manufacturers have more assembly line variables to focus on, not to mention their very own consumers tripping over the same obstacles in distributorships.

There are fewer shortcoming when wearing a harness in contrast to the hazards related to harness tie down limitations and other health risks associated with minimal harness use. For instance, some loop harnesses that permit liberal orbital tool motion may tend to isolate more vertical resistance at yard tool handle locations in comparison to span harnesses like those for balancing a load and forces on extended booms or elongated structures like bridges. Functioning harnesses can also become a worry when they repeatedly get rolled up during combined lawn edging and grounds trimming chores.

Some residential yard tools are sold without a harness, but these power tools can vibrate excessively which tends to contradict the beneficial use of a pulse equalizing harness, even when light work is required over several periods. Commercial yard tools typically come equipped with a harness because these devices are more dangerous to operate during longer periods as compared with other counterparts. Residential and commercial yard tools are either kept at a base as illustrated in U.S. Pat. No. 6,619,485 B1 or they may be suspended in a vertical position as shown in U.S. Pat. No. 5,669,515. Prior to completing grounds chores many yard tools are brought out to an open and flat surface area for initial start-up activity. In other instances, yard tool preparation can be completed on a stand or from a bench in a repair shop, such as that seen in U.S. Pat. No. 6,457,695 B1. Yard machines can be brought to several different work sites before tool operation begins like the example given in U.S. Pat. No. 6,173,842 B1 or as an open trailer representation found in U.S. Pat. No. 5,647,489. In all of these instances, a yard tool can come equipped with a harness. Accordingly, the inability to stabilize a harness during tool preparation could slow down yard work.

Harnesses could become difficult to tie down or wear if they are bulky and uncomfortable, especially if worn in hot climates. For instance, U.S. Pat. No. 5,718,364 provides means for a plurality of straps with several compartments that could dampen a groundskeeper's operation. In addition, U.S. Pat. No. 6,315,179 BI consists of specific design features like an open harness hook with restricted lateral pivot motion and a belt clip that limits full release of potentially dangerous rotary tools. Some trucks provide tie-downs for securing handheld power tools from being damaged during transport like the cargo bed arrangement described in U.S. Pat. No. 7,281,889 B2. Nonetheless, large tool tie-downs are too heavy to carry by hand with a harness whereas smaller tie-downs like U.S. Pat. No. 6,470,535 B1 are known to dislodge which will make it difficult to secure a harness.

Prior art deficiencies generally demonstrate an inability to secure harnesses when yard tools are set aside or when they are unneeded. The problem doesn't appear to exist when harnesses are recoiled after completing grounds maintenance chores. To the contrary, it takes only a few seconds to retract or bundle up a harness to an idle state, but there appears to be little means for locking the current art in place. Abundant material also makes it more difficult to tie harnesses together.

The truth is that yard work should become easier when pleasing, practical and playable harnesses are encouraged to properly suspend yard tools along a lanscaping route. Greater harness experience can further be helpful for developing better energy conservation plans because that's what they are known for absorbing. Nevertheless, having to deal with a plurality of drawbacks could be why many harnesses are taken for granted. This US patent application attempts to satisfy a few of the yard tool harness drawbacks.

### BRIEF SUMMARY OF THE INVENTION

The primary object of the invention is to provide a retractable harness with a tie-down to a band.

Another object of the invention is to provide the tie-down with unions that will secure the harness when not in use.

Another object of the invention is to provide the harness with a safe distance away from power sources at all times.

A further object of the invention is to provide the harness with a safe distance away from sharp tools at all times.

Yet another object of the invention is to provide the harness with a safe distance away from ground level at all times.

Still yet another object of the invention is to provide the harness with a tool safety release button and secure tool latch.

Another object of the invention is to provide the tie-down to hold the harness intact when moving at speeds up to 70 mph.

Another object of the invention is to provide the harness with a swivel to maneuver power tools.

A further object of the invention is to provide the harness with means to connect to a brace at one end and to a body or tool at the other end.

Other objects and advantages of the present invention will become apparent from the following descriptions, taken in connection with the accompanying drawing, wherein, by way of illustration and example, an embodiment of the present invention is disclosed.

In accordance with a preferred embodiment of the invention, there is disclosed a yard tool harness tie-down comprising: a band, the band generally connected above a yard tool equilibrium point, the band having a north brace, the band having a south brace, the band having an east brace, the band having a west brace, the north brace having means to be connected to a harness, the south brace connected to a swivel button, the swivel button having means to connect to a harness clip, the harness clip having means to connect to a plurality of yard tools, the east brace connected to a fixed tie-down, the fixed tie-down connected to a outer union, the west brace connected to an adjustable tie-down, the adjustable tie-down connected to a outer union, the inner union having means to couple with the outer union, and the inner and outer unions having means to tie down the yard tool harness close to the harness clip.

In accordance with a preferred embodiment of the invention, there is disclosed a process for A yard tool harness tie-down comprising: a band, the band generally connected above a yard tool equilibrium point, the band having a north brace, the band having a south brace, the band having an east brace, the band having a west brace, the north brace having means to be connected to a harness, the south brace connected to a swivel button, the swivel button having means to connect to a harness clip, the harness clip having means to connect to a plurality of yard tools, the east brace connected to a fixed tie-down, the fixed tie-down connected to a outer union, the west brace connected to an adjustable tie-down, the adjustable tie-down connected to a outer union, the inner union having means to couple with the outer union, and the inner and outer unions having means to tie down the yard tool harness close to the harness clip.

### BRIEF DESCRIPTION OF THE DRAWINGS

The drawing constitutes a part of this specification and includes exemplary embodiments to the invention, which may be embodied in various forms. It is to be understood that in this instance various aspects of the invention may be shown simplified to emphasis the main importance of encouraging the use of and safe tie down of a yard tool harness.

FIG. 1 is a front view of the yard tool harness tie-down illustrated in an unlocked sideway position and a partial view of a shoulder harness shown in an upward support position.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

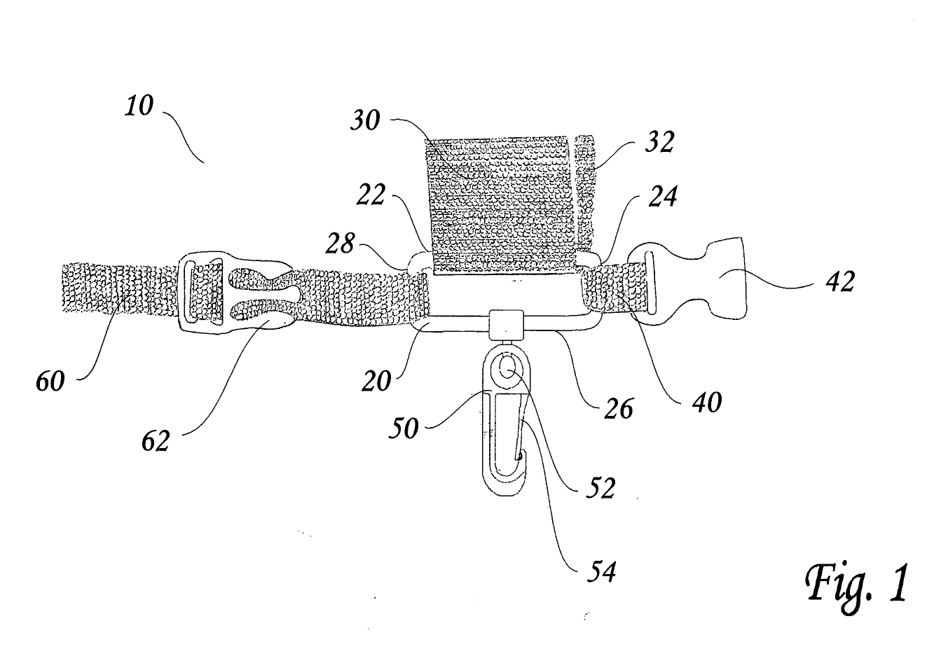

Referring exclusively to FIG. 1, a yard tool harness tie-down 10 consists of a rectangular band 20 generally comprising a north 22, east 24, south 26, and west 28 brace. However, the band 20 can be having a plurality of geometric shapes and different structural materials according to sound engineering judgment. A harness 30 (partially shown) is connected to the band 20 north brace 22 by a loop 32. But, the the harness can have several loops and the harness 30 can connect to one, or more bands according to sound engineering judgment. The harness 30 can be made of different materials, having a variety of widths and lengths capable of being held to the band 20.

The east brace 24 is connected to a fixed tie-down 40 which can be made of a nylon, fabric or more rigid material according to sound engineering judgment. The fixed tie-down 24 is connected to an outer union 42. But, the fixed tie-down 24 can be a stretchable carrying net or case (both not shown) that will hold reasonable waste when the harness 30 is removed for use. The outer union 42 can be a different fastener known to the art.

The west brace 28 is connected to an adjustable tie-down 62 which can further be made of a flexible nylon fabric or more rigid material according to sound engineering judgment. The adjustable tie-down 60 is connected to an inner union 62. But, the inner union 62 can be a different fastener known to the art or eliminated if so desired. There is about three and one-half inches of clearance for the inner union 62 to loop the harness 30 within the adjustable tie-down 60. The inner 62 and outer 42 unions are capable of coupling together to form a secure band unit. If so needed, the inner 62 and outer 42 union coupling can be coupled to an operator's belt or belt loop according to best work practices and sound engineering judgment.

The south brace 26 having a swivel button 52 that will preferably connect to a harness clip 50 near a yard tool's equilibrium point (not shown). A yard tool can be released from the harness 30 by means of pressing in on the swivel button 52 according to sound engineering judgment which allows the harness clip 50 to separate from the harness 30. It is important to note that one hand can control a yard tool frontal steering grip (not shown) while a rearward hand continues to wrap around the power control grip (not shown) while a thumb or the like releases the swivel button 52 so that there is maximum machine stability when the harness 30 is released from the harness clip 50. In addition, the harness clip 50 provides a spring loaded latch 54 to prevent tools from translating out of the harness 30.

When yard work is completed the harness 30 is ready to be retracted or the like and held firmly compacted by fastening the inner 62 and outer 42 unions together. It is important to note that there is less danger during a typical fifteen minute cooling down period of yard tools when a harness 30 is properly reeled in and quickly bundled together. Furthermore, the grounds maintenance process is safer by having the harness 30 suspended tightly at most times.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A yard tool harness tie-down comprising:
a band;
the band generally connected above a yard tool equilibrium point;
the band having a north brace;
the band having a south brace;
the band having an east brace;
the band having a west brace;
the north brace having means to be connected to a harness;
the south brace connected to a swivel button;
the swivel button having means to connect to a harness clip;
the harness clip having means to connect to a plurality of yard tools;
the east brace connected to a fixed tie-down;
the fixed tie-down connected to a outer union;
the west brace connected to an adjustable tie-down;
the adjustable tie-down connected to an outer union;
the inner union having means to couple with the outer union;
the inner and outer unions having means to couple with a plurality of safety supports; such as, a belt or belt loop; and
the inner and outer unions having means to tie down the yard tool harness to the band.

2. A process for A yard tool harness tie-down comprising:
a band;
the band generally connected above a yard tool equilibrium point;
the band having a north brace;
the band having a south brace;
the band having an east brace;
the band having a west brace;
the north brace having means to be connected to a harness;
the south brace connected to a swivel button;
the swivel button having means to connect to a harness clip;
the harness clip having means to connect to a plurality of yard tools;
the east brace connected to a fixed tie-down;
the fixed tie-down connected to a outer union;
the west brace connected to an adjustable tie-down;
the adjustable tie-down connected to an outer union;
the inner union having means to couple with the outer union;
the inner and outer unions having means to couple with a plurality of safety supports; such as, a belt or belt loop; and
the inner and outer unions having means to tie down the yard tool harness to the band.
